(19) United States
(12) Patent Application Publication
(10) Pub. No.: US 2006/0256459 A1
(43) Pub. Date: Nov. 16, 2006

(54) Rear viewing device for an automobile

(75) Inventors: Vincent Izabel, Chilly Mazarin (FR); Laurent Simon, Richebourg (FR)

Correspondence Address: OSHA LIANG L.L.P., 1221 MCKINNEY STREET, SUITE 2800, HOUSTON, TX, 77010, US

(73) Assignee: Valeo Systemes d'Essuyage, La Verriere (FR)

(21) Appl. No.: 10/566,462

(22) PCT Filed: Jul. 26, 2004
(86) PCT No.: PCT/EP04/08338

§ 371 Date: Jun. 9, 2006

(30) Foreign Application Priority Data
Jul. 29, 2003 (FR) 0309363

(51) Int. Cl. G02B 7/182

(52) U.S. Cl. 359/872

(57) ABSTRACT

A rear vision device for a motor vehicle includes a video camera intended to be integrated fixedly at a rear of a motor vehicle, a flap mounted so as to be able to move between a closed position and an open position, in which the said flap is disposed respectively in front of and away from the a lens of the video camera, and drive means able to drive the flap in movement between the closed position and the open position. The flap includes pivoting means defining a pivot axis and allowing passage from one position to another. The flap also includes a curved part and articulation arms. The articulation arms are fixed to the curved part and the pivoting means.

The present invention concerns a rear vision device for a motor vehicle, functioning by means of a video camera integrated in the rear part of the said vehicle.

The invention finds a particularly advantageous but not exclusive application in the field of assistance in parking motor vehicles.

It is known how to use a video camera for achieving rear vision on a motor vehicle, that is to say for monitoring the part of the road which is situated behind the said vehicle when the latter is moving, and in particular to monitor the behaviour of other users. The image produced is projected onto a screen which is positioned in the cabin, substantially in the field of vision of the driver. However, this type of use at the present time is essentially reserved for motor show prototypes, because of the fact that it constitutes above all an expensive alternative to conventional rear view mirrors, even if the gain in comfort is not insignificant.

On the other hand, the use of a video camera for assisting parking is tending to be developed more and more on mass production automobiles. The idea consists of projecting, still on a screen placed substantially in the field of vision of the driver, the image coming from a video camera aimed at the space directly adjacent to the rear part of the automobile. It is not a question here of a simple alternative, but truly a novel function for assisting the driver during parking manoeuvres, and in particular during reversing.

Whatever the purpose of such a rear vision device, the video camera is normally and highly logically located at the rear part of the vehicle. Thus it can be integrated directly in the bodywork or in any element composing the rear part of the vehicle, such as for example a bumper, an aileron, a tailgate stay, etc. The video camera is moreover generally mounted in a fixed manner since its positioning, previously mentioned, perfectly matches its function. It should be noted that the lens of the video camera may be protected or not by a transparent protective screen. Whatever the case, the installation of the video camera is commonly effected so that the end of the lens or protective screen extends so as to be substantially flush with respect to its support element.

This type of mounting does certainly offer structural simplicity able to contain costs. It also has the advantage of minimising the bulk of the device, for greater ease of installation. However, it offers no protection vis-à-vis soiling, and proves particularly vulnerable to impacts and other acts of vandalism.

There do indeed exist a few rear vision devices equipped with movable protective flaps, but they are combined with retractable cameras. Whatever the embodiment chosen, this involves the presence of a deployment mechanism that is complex and bulky since it is necessary to provide the mobility of both the flap and video camera. This structural complexity has the drawback of considerably increasing the cost price of such a price and proportionally decreasing the reliability of the system. The significant increase in bulk, for its part, is of such a nature as to interfere with or even prevent the installation of such a device on certain parts of the motor vehicle. The connections are also complicated to manage because of the movement.

Thus the technical problem to be resolved, through the object of the present invention, is to propose a rear vision device for a motor vehicle, comprising a video camera intended to be integrated fixedly at the rear of an automobile, a rear vision device which would avoid the problems of the prior art by offering in particular true protection against soiling, whilst guaranteeing the integrity of the camera in particular in the case of impacts or acts of vandalism.

The solution to the technical problem posed consists, according to the present invention, of the fact that the rear vision device also comprises a flap mounted so as to be able to move between a closed position and an open position in which the said flap is disposed respectively in front of and away from the lens of the video camera, as well as drive means able to drive the flap in movement between the closed position and the open position.

Such a rear vision device makes it possible to give either parking assistance and/or rear vision.

The fact that the video camera is intended to be integrated fixedly at the rear of a motor vehicle means that it can be installed simply on the bodywork or on any other element of the rear part of the vehicle, but also that it can be integrated directly inside, partially or totally.

The mobility of the flap can be effected in any movement, since the said flap is able to be moved between the closed position in which it masks the lens of the video camera and the open position in which it leaves clear the field of the said video camera. The flap can thus be mounted so as to be able to move in translation, in rotation, tilting, pivoting, or in any combination of these movements.

The protection offered by the flap is given above all at the lens of the video camera since it is a case of the single external element for which lack of cleanliness and/or integrity would be liable to call into question the function of the rear vision device.

The invention as thus defined combines the previously mentioned advantages of a fixed camera with those of a movable protection flap. The flap in fact provides effective protection against soiling, impact and/or vandalism, in particular when the rear vision device is not in use.

The present invention also concerns the characteristics which will emerge during the following description and which must be considered in isolation or in accordance with all their possible technical combinations.

This description, given by way of non-limiting example, will give a better understanding of how the invention can be implemented, with reference to the accompanying drawings, in which:

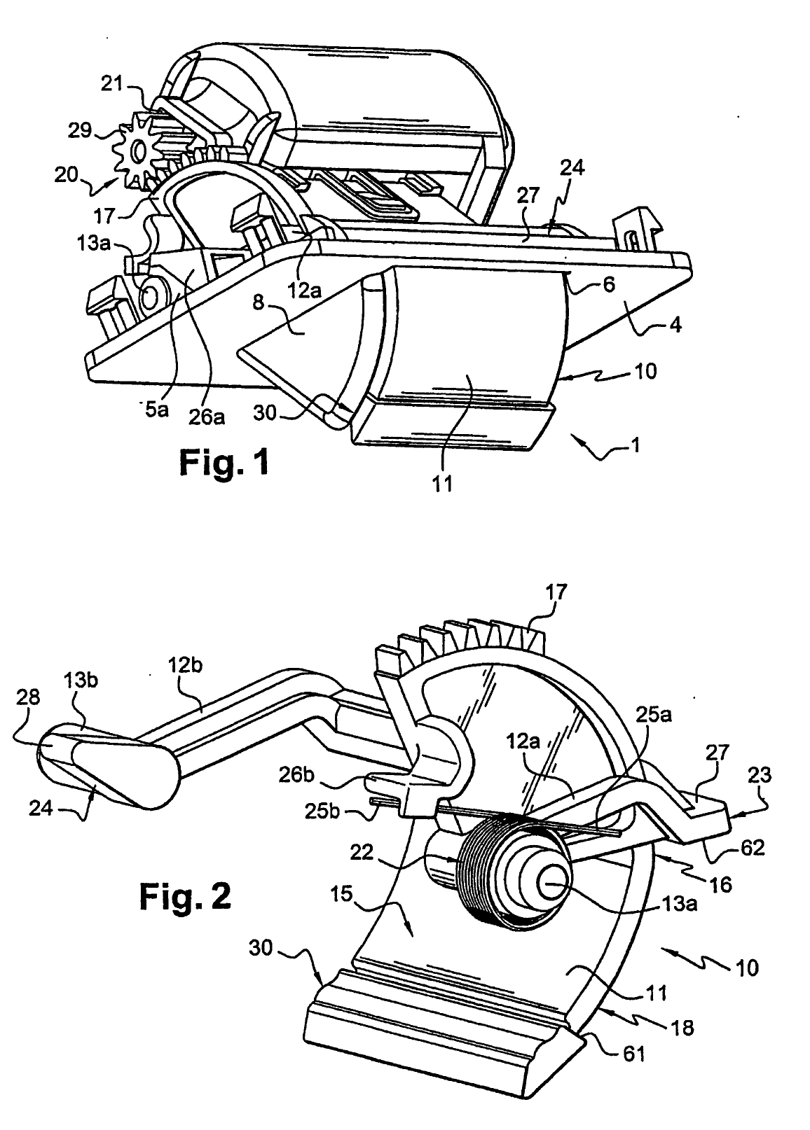

FIG. 1 illustrates in perspective a rear vision device according to a first embodiment of the invention.

FIG. 2 shows in rear perspective the flap of the rear vision device of FIG. 1.

FIG. 3 depicts in detail the elastic return means of the rear vision device of FIG. 1.

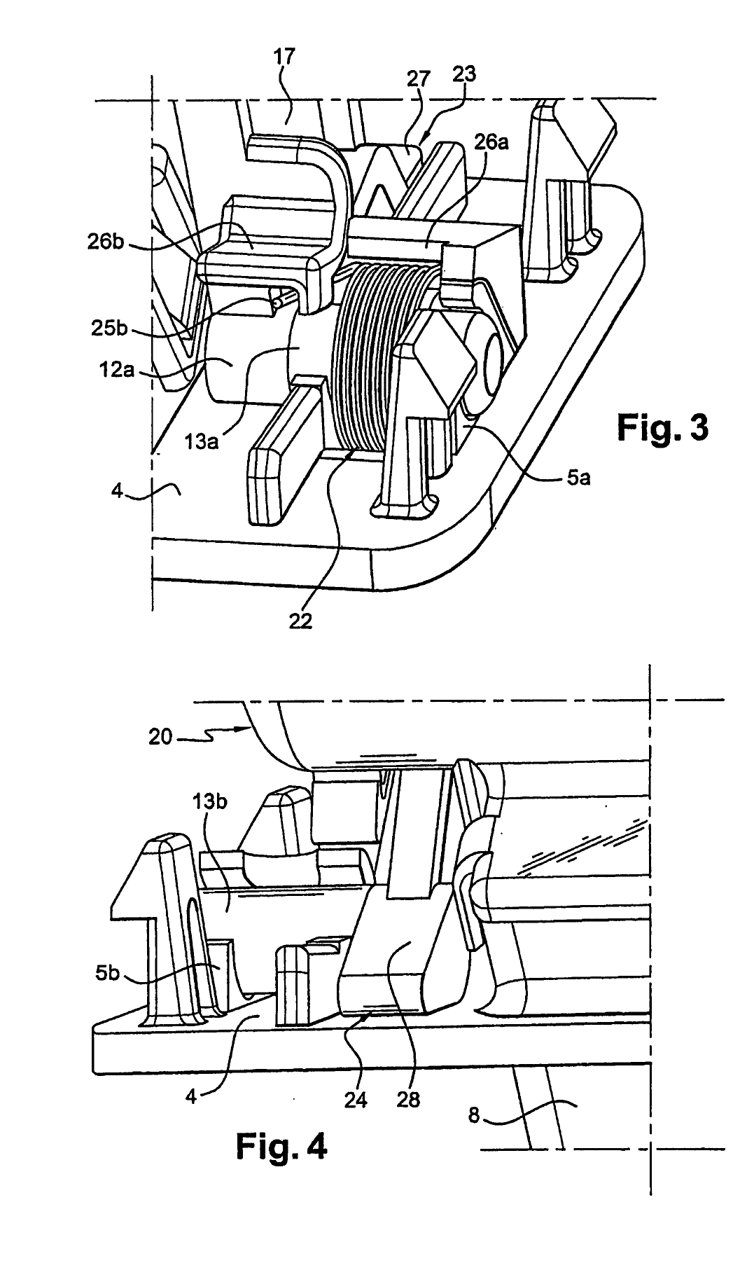

FIG. 4 shows the stop means of the rear vision device of FIG. 1, in the active position.

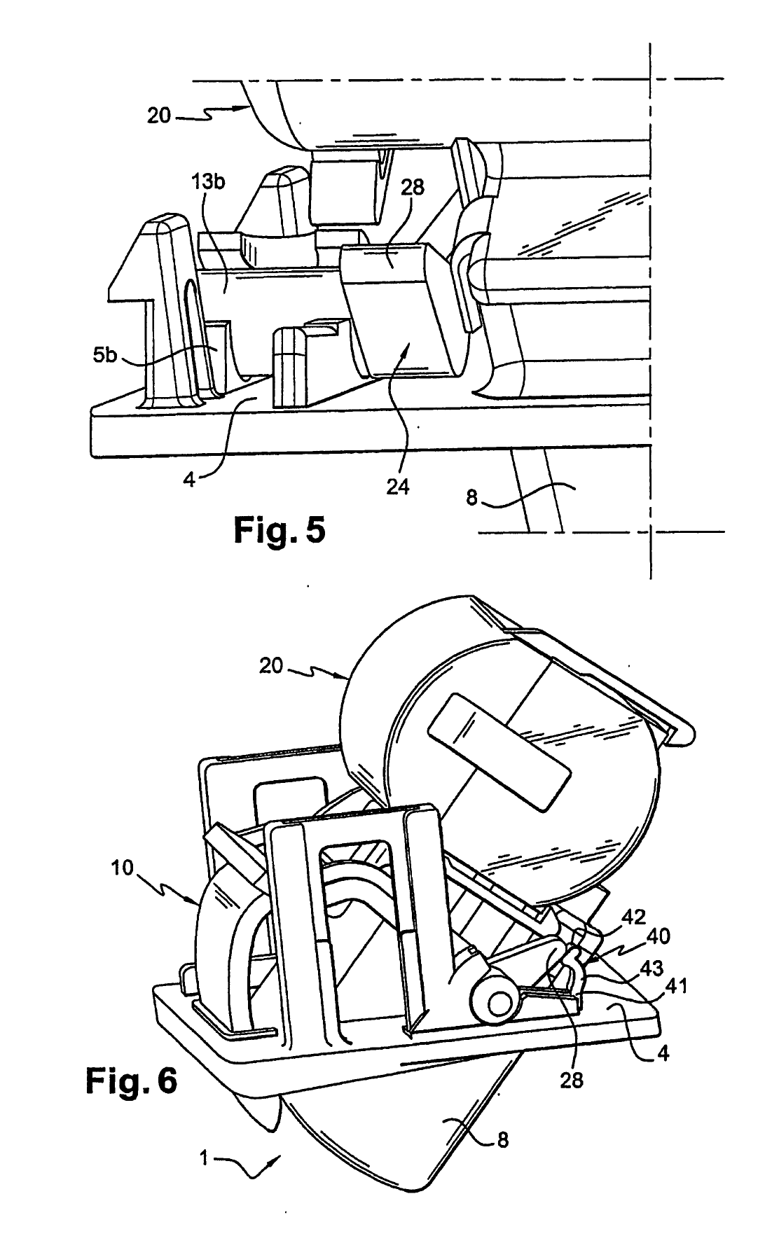

FIG. 5 is a view similar to FIG. 4, but with the stop means in the passive position.

FIG. 6 illustrates a first variant embodiment comprising means of locking in the passive position.

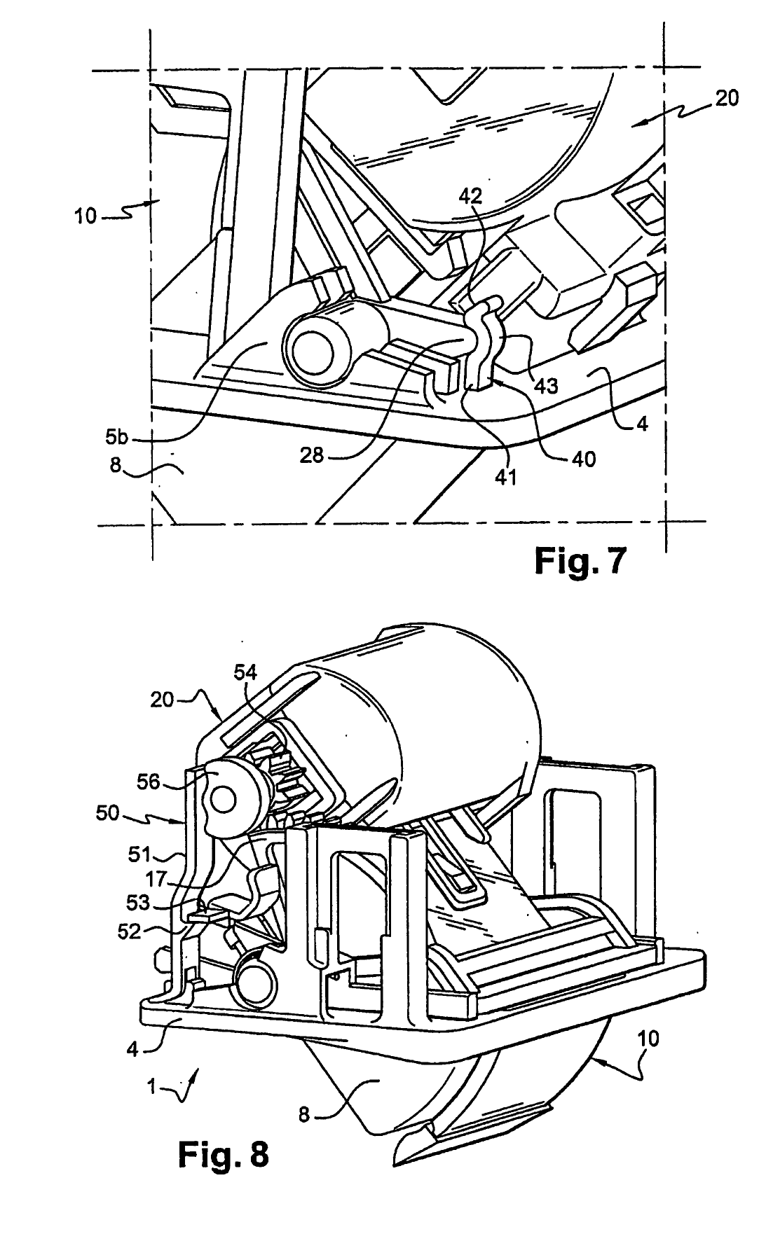

FIG. 7 constitutes a view similar to FIG. 6 but with the locking means in the active position.

FIG. 8 shows a second variant embodiment incorporating locking means depicted in the active position.

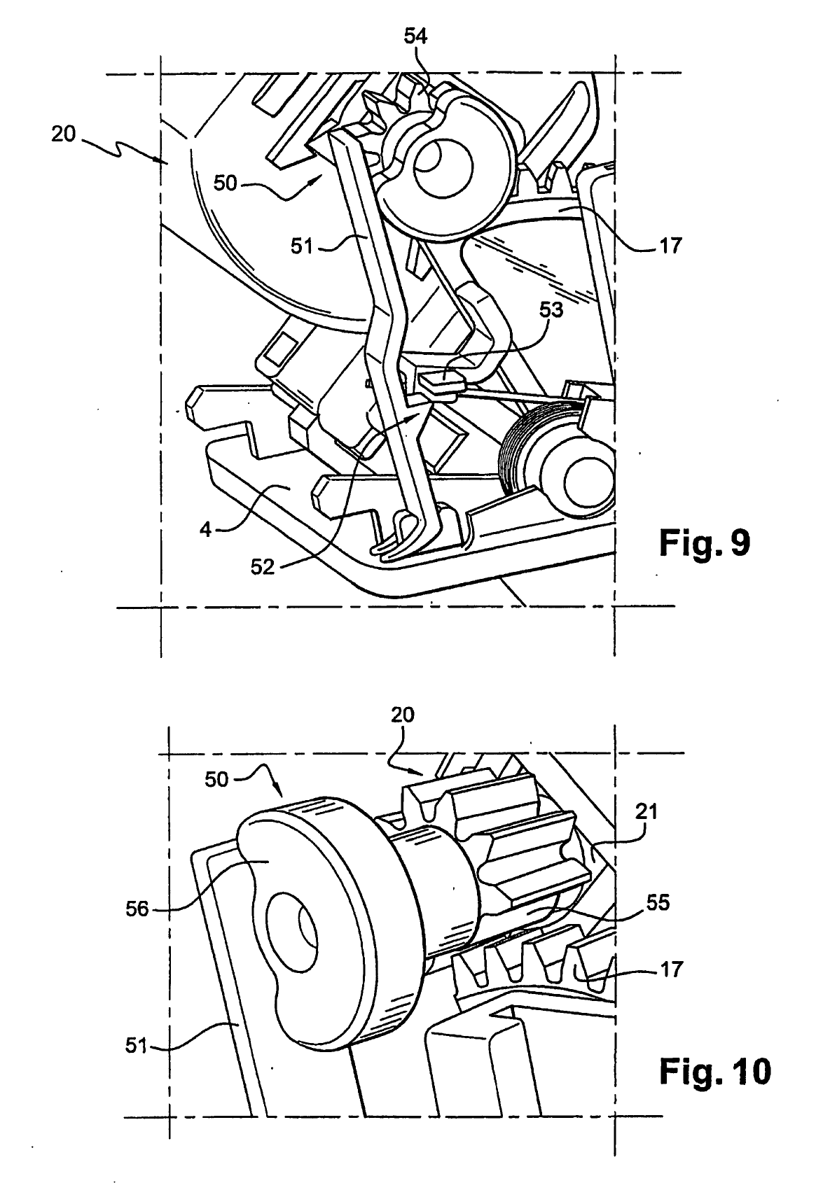

FIG. 9 is a view similar to FIG. 8 but with the locking means in the passive position.

FIG. 10 shows in detail part of the locking means of FIG. 8.

FIG. 11 illustrates the cleaning means and the sealing means of the rear vision device of FIG. 1, when the flap is in the open position.

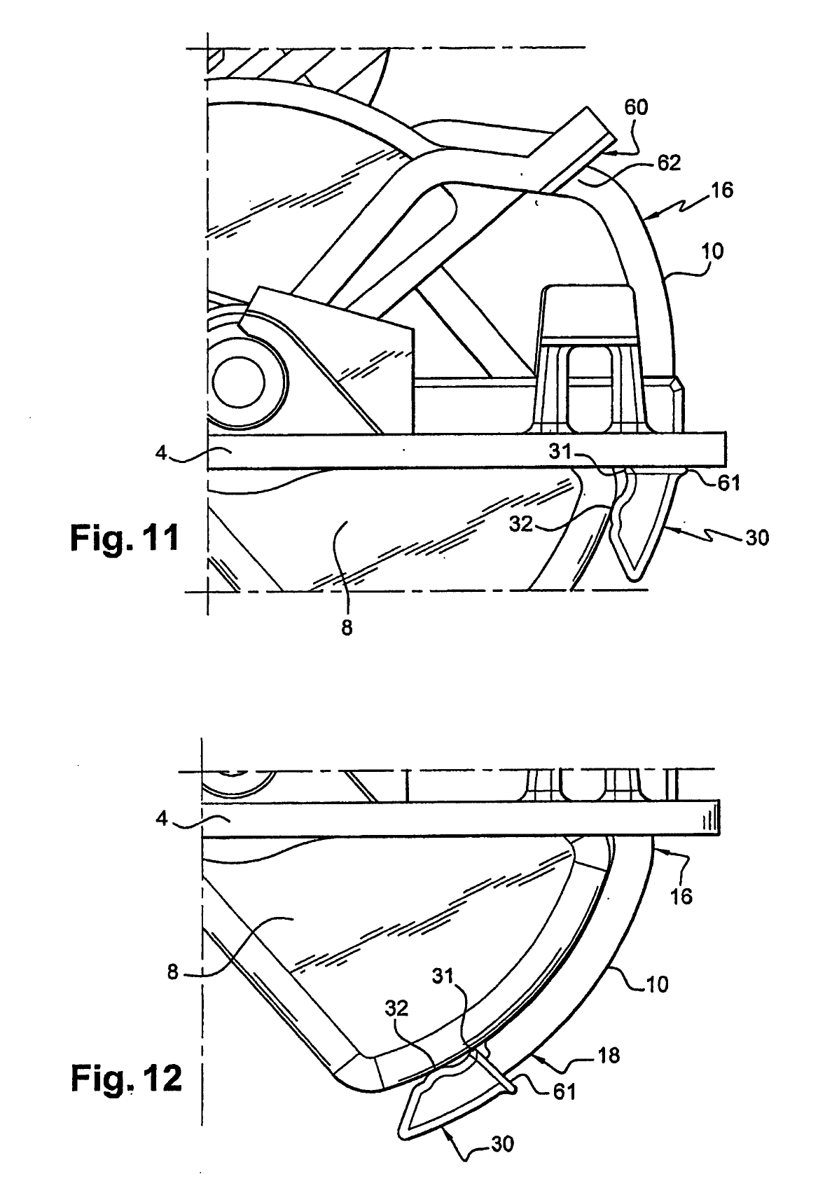

FIG. 12 constitutes a view similar to FIG. 11, but with the flap in the closed position.

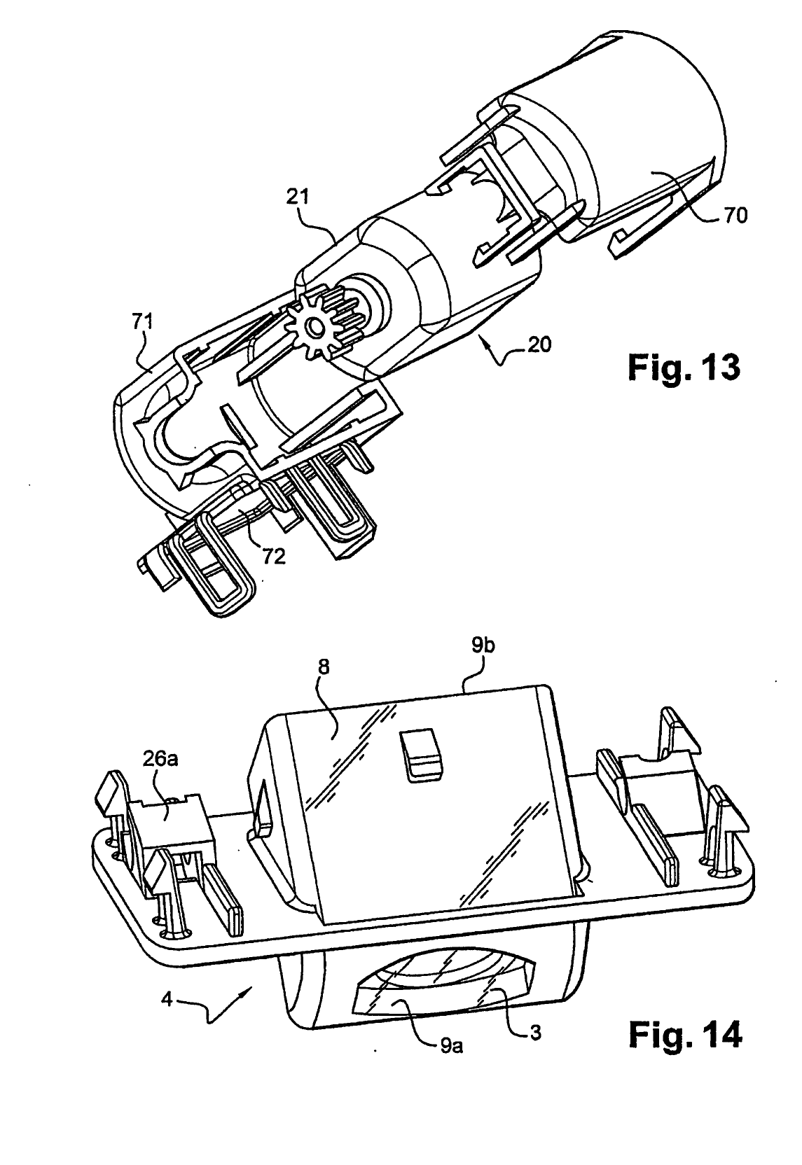

FIG. 13 depicts part of the drive means of the rear vision device of FIG. 1.

FIG. 14 shows in detail the support of the rear vision device of FIG. 1.

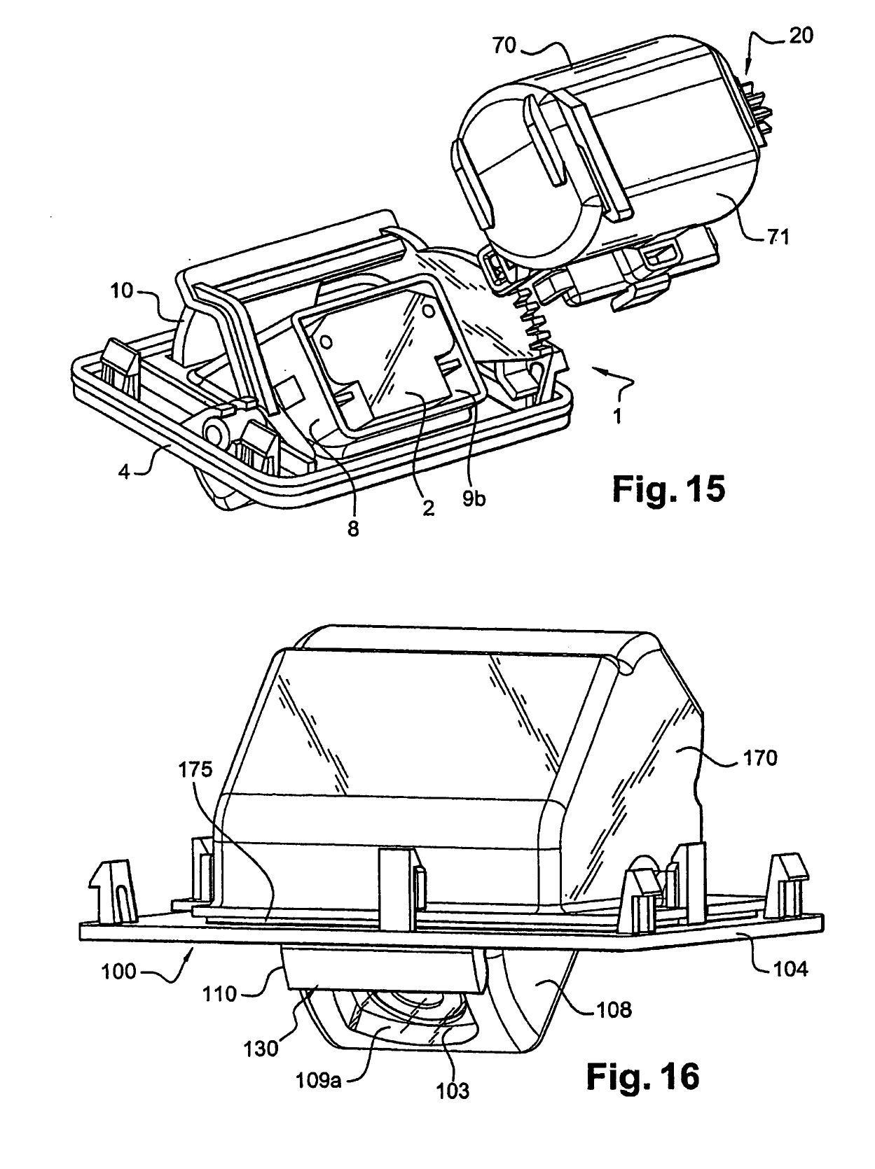

FIG. 15 shows the rear vision device of FIG. 1 during assembly.

FIG. 16 illustrates in perspective a rear vision device according to a second embodiment of the invention.

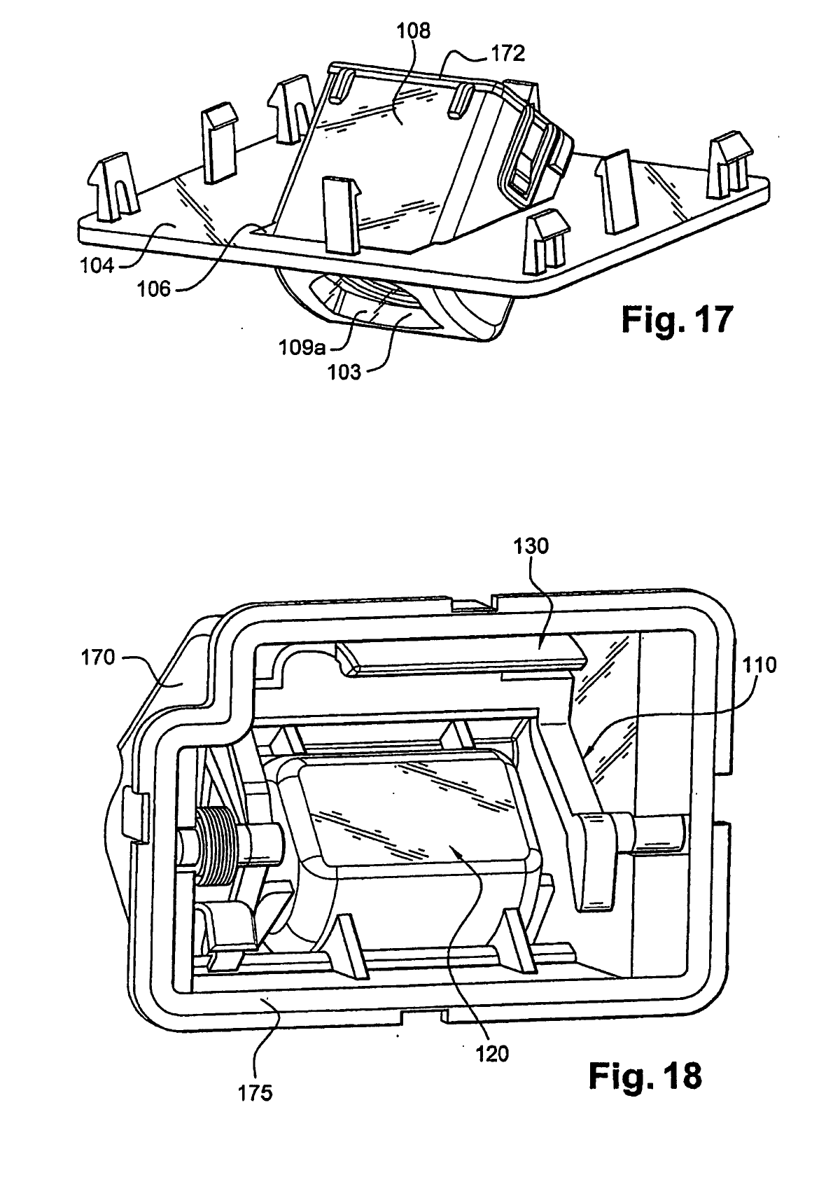

FIG. 17 depicts in perspective the support of the rear vision device of FIG. 16.

FIG. 18 is a view from below of the protective casing of the rear vision device of FIG. 16.

For reasons of clarity, the same elements have been designated by identical references. Likewise, only the elements essential for an understanding of the invention have been shown, and this without following scale and schematically.

FIG. 1 illustrates a rear vision device 1 which comprises conventionally a video camera 2 whose lens is protected by a transparent screen 3. In this particular embodiment, chosen solely by way of example, the video camera 2 and the protective screen 3 are fixed to a support 4 which is intended to be installed fixedly at the rear of a motor vehicle.

In accordance with the object of the present invention, the rear vision device 1 is also provided with a flap 10 which is mounted so as to be able to move pivotally between a closed position (FIG. 12) and an open position (FIG. 11) in which the said flap 10 is disposed respectively in front of and away from the protective screen 3. The rear vision device 1 also comprises drive means 20 which are able to pivotally drive the flap 10 between the closed position and the open position.

According to one particularity of the invention, the drive means 20, 120 are able to immobilise the flap 10, 110 in at least one intermediate position situated between the closed position and the open position.

As can be seen more clearly in FIG. 2, the flap 10 comprises a curved part 11, in the form of a tubular portion, and two articulation arms 12a, 12b each carrying at their free end a cylindrical part 13a, 13b, forming a pivot axis. The two articulation arms 12a, 12b are respectively fixed to the two ends of the top edge 14 of the curved part 11 and extend on the same side as the concave face 15 of the said curved part 11. The cylindrical parts 13a, 13b for their part are coaxial with respect to each other but also with respect to the axis corresponding to the curvature of the concave face 15 of the curved part 11. The whole is arranged so that the cylindrical parts 13a, 13b can fit together and cooperate by rotation with two open bearings 5a, 5b fixed to the support 4; the curved part 11 then being in a position to move along the protective screen 3 between the closed position and the open position.

In this currently preferred embodiment of the invention, the drive means 20 comprise first of all an electric motor 21 which is able to pivotally drive the flap 10 from the closed position to the open position. The drive means 20 are also provided with elastic return means 22 which are able to pivotally drive the flap 10 from the open position to the closed position. The drive means 20 are also provided with stop means 23, 24 which are able to stop the movement of the flap 10 in the open position and in the closed position.

In this example embodiment, the electric motor 21 is entirely conventional since its drive shaft is able to turn only in one direction, which corresponds here advantageously to that of opening the flap 10. In practice, when the flap 10 comes into abutment, the electronics controlling the electric motor 21 adapts the supply voltage so as to relieve the said electric motor 21, whilst guaranteeing the holding of the said flap 10 in the open position. As soon as the electric motor cuts off, the flap 10 is automatically returned to the closed position under the effect of the elastic return means 22.

In accordance with FIGS. 2 and 3, the elastic return means 22 are for their part in the form of a spiral spring which is conventionally tensioned around the cylindrical part 13a, with its free ends 25a, 25b cooperating by locking contact with two stops 26a, 26b respectively fixed to the support 4 and flap 10.

The stop means 23, 24 are, in this example, of a quite distinct design.

FIGS. 1 and 2 show more particularly the stop means 23 which stop the movement of the flap 10 in the closed position. It consists here of a wide bar 27, which is provided all along the proximal part 16 of the curved part 11 and which is able to cooperate by locking contact with the support 4 when the said curved part 11 has completely covered the protective screen 3.

As can be seen in particular in FIGS. 2, 4 and 5, the stop means 24 stopping the movement of the flap 10 in the open position consists here of a pawl 28 which is fixed to the cylindrical part 13b and which extends rearwards with respect to the rest of the flap 10. The whole is arranged so that the pawl 28 comes into contact with the support 10 only when the flap 10 is in the open position (FIG. 4). The rest of the time, and in particular when the flap 10 is in the closed position (FIG. 5), the pawl 28 is positioned at a distance from the support 4.

However, according to a variant embodiment, the drive means 20 could very well comprise only a simple electric motor of the stepping type. The fact that the rotation of the drive shaft of such a motor can take place reversibly in one direction or the other makes it possible to drive the flap 10 pivotally either from the closed position to the open position or vice versa. The fact that the rotation of the drive shaft can also be controlled angularly also makes it possible to stop the movement and immobilise the flap 10, either in the open position or in the closed position. This configuration advantageously makes it possible to dispense with any elastic return means 22 and other stop means 23, 24.

Whatever the variant adopted, the transmission to the movable flap 10 of the movement generated by the drive means 20 can be effected by any known means, and in particular by gears, friction wheels, belt, etc. In accordance with FIG. 1, the transmission of the movement is achieved in this example embodiment by making a pinion 29 fixed to the drive shaft of the electric motor 21 cooperate by meshing with a toothed sector 17 secured to the flap 10.

FIGS. 6 and 7 depict a first variant embodiment in which the flap 10 is able to be driven manually in movement between the closed position and a storage position (FIG. 7) situated beyond the open position (FIG. 6). Moreover, the rear vision device 1 is provided with locking means 40 which are able to immobilise the flap 10 in the storage position (FIG. 7). This characteristic enables the user to push the flap 10 from the outside when the drive means 10 are broken down or their functioning is defective. The rear vision function can thus advantageously be preserved.

In this example embodiment, the locking means 40 consist of a tongue 41 fixed to the support 4, the distal end 42 of which is able to constitute the stop means 23 (FIG. 6) and the central part 43 of which is conformed so as to be able to cooperate by fitting together with the distal end of the pawl 28 (FIG. 7). Obviously the whole is arranged so that the drive means 20 are not able to use the locking means 40, that is to say to drive the flap 10 from the open position to the storage position. In the same way, neither the said drive means 20 nor any elastic return means 22 are calibrated so as to allow deactivation of the locking means 40. In concrete terms, only the user is in a position to cause the engagement or disengagement of the distal end of the pawl 28, from the central part 43 of substantially complementary shape, by elastic deformation of the tongue 41.

FIGS. 8 to 10 show a second variant embodiment which is completely incompatible with the previously mentioned characteristic since it concerns the protection of the rear vision device 1 against tampering. This variant is distinguished by the presence of locking means 50 which are able to lock the flap 10 in the closed position, in the absence of use of the drive means 20. This means that only the drive means 20 are able to activate or deactivate the locking means 50 and that consequently the movement of the flap 10 cannot be operated manually from the outside.

In the example embodiment in FIGS. 8 to 10, the locking means 50 comprise first of all a tongue 51 which is mounted so as to pivot elastically on the support 4 and which is provided with a stop 52 able to cooperate by contact with a lug 53 fixed to the flap 10. The locking means 50 next comprise a specific pinion 54 which is distinguished by the fact that it comprises a non-toothed sector, that is to say a smooth part 55. This specific pinion is also fixed to the transmission shaft of the electric motor 21 instead of the pinion 29 in order to be able to cooperate by meshing with the toothed sector 17 fixed to the flap 10. Finally, the locking means 50 comprises a cam 56 which is fixed to the transmission shaft of the electric motor 21 and which is able to cooperate by sliding contact of the distal end of the tongue 51.

The whole is arranged so that, in the closed position (FIG. 8), the tongue 41 is in contact with the non-circular part of the cam 56, the smooth part 55 of the specific pinion 54 is opposite the toothed sector 17 (FIG. 10) and the lug 53 fixed to the flap 10 is in abutment against the stop 52 of the said tongue 51. The latter characteristic prevents any mobility of the flap 10 and consequently ensures locking in the closed position.

As soon as the drive means 20 are activated, the transmission shaft of the electric motor 21 commences its rotation, which has the effect of making the cam 56 and the specific pinion 54 turn, but the latter is not yet able to mesh on the toothed sector 17. Whatever the case, the cam 56 progressively pushes the tongue 51, which deforms elastically. The stop 52 thus disengages just as progressively from the lug 53 until there is total separation, so that the locking of the flap 10 is then released. The toothed portion of the specific pinion 54 only then commences to mesh progressively with the toothed sector 17, consequently causing the pivoting of the flap 10.

It should be noted that the locking of the flap 10 by the locking means 50 is achieved simply by virtue of a kinematics that is the reverse of that previously described.

In this particular embodiment, the flap 10 is mounted so as to be able to move through a slot 6 which is provided in the support 4. However, according to one particularity of the invention, the rear vision device 1 is also provided with sealing means 50 which are able to seal the space between the flap 10 and the support 4. The aim is to protect, essentially from dust and moisture everything which is situated behind the support 10 and in particular the video camera 2.

As can be seen in FIGS. 11 and 12, the sealing means 60 of this example embodiment are provided first of all with a first seal 61 which is positioned at the distal end 18 of the flap 10 and which is able to seal the space between the flap 10 and the support 4 when the said flap 10 is in the open position. The sealing means 60 also comprise a second seal 62 which for its part is positioned at the proximal end 16 of the flap 10 and which is able to seal the space between the flap 10 and the support 4 and the said flap is in the closed position.

In accordance with a variant embodiment or as a supplement to the embodiment described previously, the sealing means 60 can comprise a third seal which is fixed to the support 4, which is positioned at the slot 6 and which is able to cooperate by sliding contact with the flap 10.

It was seen previously that, in this example embodiment, the rear vision device 1 comprised a transparent screen 3 intended to protect the lens of the video camera 2. Thus, according to an advantageous characteristic of the invention, the rear vision device 1 is also provided with cleaning means 30 which are able to clean the protective screen 3 during the movement of the flap 10 between the closed position and the open position.

According to one particularity of the invention, the external surface of the protective screen 3 is substantially parallel to the path of movement of the flap 10, and the cleaning means 30 comprise a scraper seal 31 which is fixed to the distal end 18 of the flap 10 and which is able to cooperate by sliding contact with the said external surface of the protective screen 3. This characteristic enables the scraper seal 31 to remain continuously in contact with the protective screen 3 during the movement of the flap 10 between the closed position and the open position. It is thus perfectly able to fulfil a wiping function as soon as the flap 10 is used.

According to another particularity visible in particular in FIGS. 11 and 12, the convex external surface of the protective screen 3 is substantially parallel to the curved path of the flap 10, and the cleaning means 30 consist of a projecting part 32 of the distal seal 61 of the flap 10, a projecting part 32 which is able to cooperate by sliding contact with the said external surface of the protective screen 3. There too, the projecting part 32 remains constantly in contact with the protective screen 3, so that it too is perfectly able to fulfil the wiping function when the flap 10 is driven pivotally between the closed position and the open position.

However, by way of variant, in the case where the lens of the video camera 2 has no protective screen 3, the rear vision device 1 could then advantageously be provided with cleaning means able to wipe the external ends of the video camera 2 when the flap 10 moves between the closed position and the open position.

FIGS. 13 to 15 illustrate the arrangement of the principal elements making up the rear vision device 1.

It should be noted first of all in FIG. 13 that the electric motor 21 is encapsulated in two protective half casings 70, 71, one of which forms an integral part of the cover 72 of the camera box. Once assembled by the fitting together of complementary fixing pieces, this assembly is able to be mounted in accordance with FIG. 15 on the support 4 which is visible in detail in FIG. 14.

The support 4 constitutes a kind of interface with the motor vehicle and confers a modular character on the rear vision device 1 according to the invention. The support here advantageously comprises a part forming a box 8 which is intended to receive and protect the video camera 2. This part forming a box 8 also has a front opening 9a intended to receive the transparent protective screen 3 and a rear opening 9b allowing the introduction of the video camera 2.

As can be seen in FIG. 15, the final mounting of the rear vision device 1 consists of assembling the assembly depicted in FIG. 13 on the box 18 provided in the support 4, by fitting the cover 72 on the rear opening 9b. It will be noted very clearly here that, in this first embodiment of the invention, the flap 10 is mounted so as to be able to move with respect to the support 4, on which also the video camera 2 is mounted fixedly.

FIG. 16 shows a rear vision device 100 according to a second embodiment of the invention.

As can be seen in FIG. 17, the structure of the support 104 is here extremely simple since it includes only the box 108 intended to receive the video camera 2. It will be noted that the front opening 109a is also closed off by a transparent protective screen 103, whilst the rear opening 109b is closed by an independent box cover 172.

In accordance with FIG. 18, this second embodiment is distinguished essentially by the fact that it comprises a flap 110 which is mounted so as to move with respect to a protective casing 170 of the drive means 120.

The majority of the other components of the rear vision device 100 being common to the first embodiment, they will not be described further here. The presence of a seal 175 at the base of the protective casing 170 in order to seal the connection with the support 104 will simply be indicated.

This second embodiment has the advantage with respect to the other of minimising the chain of dimensions between the various meshing elements, which allows greater precision of fitting and consequently reduces the various operating noises.

According to another particularity of the invention, the flap 10, 110 is produced from transparent material, for example polycarbonate. This characteristic makes it possible not to lose the rear vision function in the event of locking of the flap 10, 110 for any reason whatsoever even if the said function may be degraded in certain conditions such as for example when the locking is due to frost.

In a particularly advantageous manner, the flap 10, 110 may comprise prismatic means able to modify the field of vision of the video camera 2 according to the relative position of the said flap 10, 110 with respect to the lens of the said video camera 2. By way of example, the vision can take place downwards when the flap 10, 110 is in the closed position, thus fulfilling the parking aid function, and in the distance when the said flap 10, 110 is open or half open, then assuming the rear vision function.

Naturally, the invention also concerns any motor vehicle comprising at least one rear vision device 1, 100 as previously described.

1. A rear vision device for a motor vehicle, comprising:
a video camera intended to be integrated fixedly at a rear of a motor vehicle,
a flap mounted so as to be able to move between a closed position and an open position in which said flap is disposed respectively in front of and away from a lens of the video camera, and
drive means able to drive the flap in movement between the closed position and the open position,
the flap comprising pivoting means defining a pivot axis and allowing passage from one position to another,
wherein the flap also comprises:
a curved part; and
articulation arms,
the articulation arms being fixed to the curved part and the pivoting means.

2. The rear vision device according to claim 1, wherein the pivot axis is coaxial with respect to an axis corresponding to a curvature of a concave face of the curved part.

3. The rear vision device according to claim 1, wherein the flap also comprises a means of transmitting a movement generated by the drive means, the transmission means being fixed to the flap.

4. The rear device according to claim 3, wherein the transmission means is provided on one of the articulation arms.

5. The rear vision device according to claim 3, wherein the transmission means is made in one piece with the flap.

6. The rear vision device according to claim 1, further comprising elastic return means able to drive the flap in movement from the open position to the closed position.

7. The rear vision device according to claim 6, wherein the flap comprises a stop fixed to the flap, cooperating by locking contact with the elastic return means.

8. The rear vision device according to claim 7, wherein the stop is made in one piece with the flap.

9. The rear vision device according to claim 1, wherein the drive means are able to immobilise the flap in at least one intermediate position between the closed position and the open position.

10. The rear vision device according to claim 1, wherein the drive means comprise:
an electric motor which is able to drive the flap in movement from the closed position to the open position,
elastic return means able to drive the flap in movement from the open position to the closed position,
and stop means able to stop the movement of the flap in the open position and in the closed position.

11. The rear vision device according to claim 1, wherein the drive means comprise an electric motor of a stepping type which is able to drive the flap in movement between the closed position and the open position and to stop the movement of the said flap in the open position and in the closed position.

12. The rear vision device according to claim 1, wherein the flap is able to be driven manually in movement between the closed position and a storage position situated beyond the open position, and wherein the said rear vision device comprises locking means able to immobilise the flap in the storage position.

13. The rear vision device according to claim 1, further comprising locking means able to lock the flap in the closed position in the absence of use of the drive means.

14. The rear vision device according to claim 1, wherein the flap is mounted so as to be able to move through a slot provided in a support, and wherein the said rear vision device comprises sealing means able to seal a space between the flap and the support.

15. The rear vision device according to claim 14, wherein the sealing means comprise a first seal at a distal end of the flap able to seal the space between the flap and the support when the said flap is in the open position, and a second seal at the proximal end of the flap which is able to seal the space between the flap and the support when the said flap is in the closed position.

16. The rear vision device according to claim 14, wherein sealing means comprise a third seal which is fixed to the support, which is positioned at the stop and which is able to cooperate by sliding contact with the flap.

17. The rear vision device according to claim 1, further comprising cleaning means able to wipe an external lens of the video camera during the movement of the flap between the closed position and the open position.

18. The rear vision device according to claim 1, further comprising a transparent protective screen able to protect the lens of the video camera, and cleaning means able to wipe the said protective screen when the flap moves between the closed position and the open position.

19. The rear vision device according to claim 18, wherein an external surface of the protective screen is substantially parallel to a movement path of the flap, and wherein the cleaning means comprise a scraper seal which is fixed to a distal end of the flap and which is able to cooperate by sliding contact with the said external surface of the protective screen.

20. The rear vision device according to claim 18, wherein an external surface of the protective screen is substantially parallel to a movement path of the flap and wherein the cleaning means consist of a projecting part of a distal seal of the flap, a projecting part which is able to cooperate with by sliding contact with the said external surface of the protective screen.

21. The rear vision device according to claim 1, wherein the flap is mounted so as to be able to move with respect to a support on which the video camera is mounted fixedly.

22. The rear vision device according to claim 1, wherein the flap is mounted so as to be able to move with respect to a protective cover for the drive means.

23. The rear vision device according to claim 1, wherein the flap is produced from transparent material.

24. The rear vision device according to claim 23, wherein the flap comprises prismatic means able to modify a field of vision of the video camera according to a relative position of the said flap with respect to the lens of the said video camera.

25. A motor vehicle, comprising at least one rear vision device according to claim 1.
